(19) United States
(12) Patent Application Publication
(10) Pub. No.: US 2025/0019521 A1
(43) Pub. Date: Jan. 16, 2025

(54) RUBBER COMPOSITION, CROSSLINKED RUBBER AND TIRE

(71) Applicant: Toyo Tire Corporation, Itami-shi (JP)

(72) Inventor: Taiki Iwachi, Itami-shi (JP)

(73) Assignee: Toyo Tire Corporation, Itami-shi (JP)

(21) Appl. No.: 18/746,475

(22) Filed: Jun. 18, 2024

(30) Foreign Application Priority Data
Jul. 7, 2023 (JP) 2023-112211

(51) Int. Cl. C08K 5/3445; B60C 1/00; C08C 19/40; C08K 5/092; C08K 5/098

(52) U.S. Cl. CPC C08K 5/3445; B60C 1/0016; B60C 1/0025; B60C 1/0041; C08C 19/40; C08K 5/092; C08K 5/098; B60C 2001/005

(57) ABSTRACT

A crosslinked rubber according to an embodiment contains a diene rubber having epoxy groups crosslinked with a dicarboxylic acid represented by the general formula (1) and an imidazole represented by the general formula (2). R¹ in the formula (1) represents a divalent hydrocarbon group having 3 to 50 carbon atoms which is optionally interrupted by one or more hetero atoms. R² in the formula (2) represents a hydrogen atom or a methyl group.

HOOC—R¹—COOH (1)

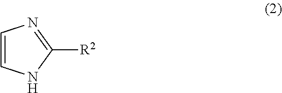

### BACKGROUND OF THE INVENTION

### 1. Field of the Invention

The present invention relates to a rubber composition, a crosslinked rubber, and a tire.

### 2. Description of Related Art

A rubber is generally crosslinked by sulfur. Material recycling of rubbers has grown in importance in recent years, but it is difficult to recycle sulfur-crosslinked rubbers because the crosslinking point of the sulfur crosslinking is not reversed.

Two major techniques are proposed for achieving the material recycling of rubbers. One is a desulfurization treatment. However, in the desulfurization treatment, it is generally difficult to selectively cut a sulfur bond and cutting of the main chain occurs together, which leads to deterioration of physical properties. The other is a substitute of sulfur crosslinking, in which the material recycling is achieved by changing sulfur crosslinking to reversible crosslinking.

As an alternative technique of the sulfur crosslinking, JP2016-501941A discloses a rubber composition containing an epoxide elastomer crosslinked with a polycarboxylic acid. In JP2016-501941A, a diene elastomer containing an epoxide functional group is mixed with a crosslinking system containing two specific polycarboxylic acids and a specific imidazole compound to thereby prepare a diene elastomer crosslinked with the polycarboxylic acids. Specifically, JP2016-501941A discloses a rubber composition in which dodecanedioic acid, a poly(acrylonitrile-co-butadiene) dicarboxy terminal, and 1-benzyl-2-methylimidazole are blended with an epoxidized natural rubber. However, JP2016-501941A does not disclose use of an imidazole that can be crosslinked by an ionic bond.

On the other hand, S. Mandal et. al., “Transformation of Epoxidized Natural Rubber into Ionomers by Grafting of 1H-Imidazolium Ion and Development of a Dynamic Reversible Network”, Applied Polymer Materials, 2022, 4, 9, 6612-6622 discloses introduction of crosslinking by an ionic bond (that is, ionic crosslinking) into an epoxidized natural rubber through grafting 1H-imidazole on an epoxidized natural rubber to form an ionomer.

### SUMMARY OF THE INVENTION

By crosslinking a diene rubber having epoxy groups by a dicarboxylic acid, the epoxy group is reacted with a carboxy group to form an ester bond. An ester bond is a re-bindable bond because it can be recombined by transesterification, and thus, has a self-restoring property and a reprocessing property. However, in some cases, the crosslinking by a dicarboxylic acid does not always give a sufficient strength and hence, there is a need to improve the strength.

In view of the above circumstance, an embodiment of the present invention has an object to improve strength of a crosslinked rubber crosslinked by a dicarboxylic acid.

Through intensive and extensive studies on an alternative technique of sulfur crosslinking, the present inventor has found that the strength of a crosslinked rubber can be improved by introducing ionic crosslinking by an imidazole in addition to crosslinking of an ester bond by a dicarboxylic acid, thus completing the present invention.

The present invention includes embodiments as follows.

[1] A rubber composition containing a diene rubber having epoxy groups, a dicarboxylic acid represented by the following general formula (1), and an imidazole represented by the following general formula (2):

HOOC—R¹—COOH (1)
wherein R¹ represents a divalent hydrocarbon group having 3 to 50 carbon atoms which is optionally interrupted by one or more hetero atoms,

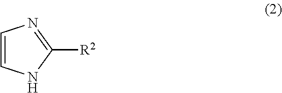

wherein R² represent a hydrogen atom or a methyl group.
   [2] The rubber composition according to [1], wherein the dicarboxylic acid is contained in an amount of 0.2 to 20 parts by mass relative to 100 parts by mass of the diene rubber.
   [3] The rubber composition according to [1] or [2], wherein the imidazole is contained in an amount of 0.5 to 15 parts by mass relative to 100 parts by mass of the diene rubber.
   [4] A crosslinked rubber containing a diene rubber having epoxy groups crosslinked with a dicarboxylic acid represented by the general formula (1) and an imidazole represented by the general formula (2).
   [5] A tire containing the crosslinked rubber according to [4].

According to the embodiments of the present invention, it is possible to improve strength of a crosslinked rubber crosslinked by a dicarboxylic acid.

### DESCRIPTION OF EMBODIMENTS

A rubber composition according to this embodiment contains a diene rubber having epoxy groups, a dicarboxylic acid represented by the general formula (1), and an imidazole represented by the general formula (2). The components may be contained as a mixture in which the components are mixed without undergoing any reaction therebetween, or may be contained as a product obtained by a reaction of at least a part thereof, or an unreacted component and a reacted component may coexist.

A diene rubber having epoxy groups (hereinafter referred to as epoxidized diene rubber) is obtained by epoxidizing a part of the carbon-carbon double bonds of the diene rubber. A diene rubber means a rubber which has a repeating unit corresponding to a diene monomer having a conjugated double bond, and contains carbon-carbon double bonds in the main chain of the polymer. Examples of the diene rubber which is a base of the epoxidized diene rubber include a natural rubber (NR), a synthesized isoprene rubber (IR), a polybutadiene rubber (BR), a styrene-butadiene rubber (SBR), a styrene-isoprene copolymer rubber, a butadiene-isoprene copolymer rubber, and a styrene-isoprene-butadiene terpolymer rubber.

The epoxidized diene rubber is preferably at least one selected from the group consisting of an epoxidized natural rubber (ENR), an epoxidized synthesized isoprene rubber, an epoxidized polybutadiene rubber, and an epoxidized styrene-butadiene rubber. The epoxidized diene rubber may more preferably contain an epoxidized natural rubber.

The epoxidized natural rubber is obtained by epoxidizing a natural rubber. As the epoxidized natural rubber, for example, a rubber obtained by epoxidizing a natural rubber by a chlorohydrin method, a direct oxidation method, a hydrogen peroxide method, an alkylhydroperoxide method, a peroxide method, or the like can be used.

The rate of epoxidation of the epoxidized diene rubber is not particularly limited, and, for example, may be 1 to 80% by mole, may be 5 to 70% by mole, may be 10 to 60% by mole, or may be 20 to 55% by mole. The rate of epoxidation is a ratio of the number of the epoxidized double bonds based on the total number of the double bonds in the diene rubber before epoxidation, and can be measured by Fourier transform nuclear magnetic resonance spectrometry.

The molecular weight of the epoxidized diene rubber is not particularly limited, and an epoxidized diene rubber that is solid at a normal temperature (25° C.) can be preferably used.

In a rubber composition according to an embodiment, the rubber component may be only the epoxidized diene rubber, but may contain, together with the epoxidized diene rubber, a non-epoxidized rubber containing no epoxy group. The non-epoxidized rubber is not particularly limited, and examples thereof include a natural rubber, a synthesized isoprene rubber, a butadiene rubber, and a styrene-butadiene rubber. Any one of the non-epoxidized rubbers can be used or two or more thereof can be used in combination.

The rubber component preferably contains the epoxidized diene rubber as a main component. The amount of the epoxidized diene rubber based on 100% by mass of the rubber component is preferably 50 to 100% by mass, more preferably 70 to 100% by mass, further preferably 80 to 100% by mass, and particularly preferably 100% by mass.

The dicarboxylic acid is a compound represented by the following general formula (1), and is a component that is to crosslink the epoxidized diene rubber. As the dicarboxylic acid, any one of the compounds represented by the formula (1) may be used or two or more thereof may be used in combination. The two carboxy groups of the dicarboxylic acid each react with an epoxy group of the epoxidized diene rubber to form an ester bond. Thus, the polymer chains of the epoxidized diene rubber are crosslinked via the dicarboxylic acid. The ester bond can be recombined by transesterification. Since the ester bond is such a re-bindable bond, the ester bond has a self-restoring property and a reprocessing property, making it possible to achieve the material recycling.

HOOC—R¹—COOH (1)

In the formula (1), R¹ represents a divalent hydrocarbon group having 3 to 50 carbon atoms which is optionally interrupted by one or more hetero atoms.

The divalent hydrocarbon group may be an aliphatic hydrocarbon group or an aromatic hydrocarbon group. The aliphatic hydrocarbon group may be saturated or unsaturated, may be linear or branched, and may contain an alicyclic structure (that is, may be an alicyclic hydrocarbon group). Preferably, the divalent hydrocarbon group is a saturated or unsaturated divalent aliphatic hydrocarbon group (preferably alkanediyl group or alkenediyl group) which may have a branched and/or alicyclic structure.

The number of carbon atoms of R¹ is preferably 6 to 45, more preferably 8 to 40, and further preferably 15 to 40. The number of carbon atoms Nc of the carbon chain that linearly links two carboxy groups of the dicarboxylic acid is preferably 3 to 30, more preferably 6 to 25, and further preferably 10 to 20. Here, the number of carbon atoms Nc is a measure of the length of the crosslinking chain, and is 16 in the case of a dimer acid DFA in Examples provided later and is 8 in the case of sebacic acid therein.

The hydrocarbon group as R¹ may be interrupted by at least one hetero atom, for example, selected from oxygen, nitrogen, and sulfur, and preferably may be interrupted by an oxygen atom, in other words, may contain an ether bond.

Specific examples of the dicarboxylic acid include glutaric acid, adipic acid, azelaic acid, sebacic acid, dodecanedioic acid, terephthalic acid, cyclohexanedicarboxylic acid, dimer acid, and hydrogenated dimer acid. Any one of the dicarboxylic acids may be used or two or more thereof may be used in combination.

The amount of the dicarboxylic acid relative to 100 parts by mass of the epoxidized diene rubber is preferably 0.2 to 20 parts by mass, more preferably 0.5 to 15 parts by mass, further preferably 0.8 to 10 parts by mass, and furthermore preferably 1 to 5 parts by mass.

The imidazole is a compound represented by the following general formula (2), and a component that is to crosslink the epoxidized diene rubber. Specifically, the imidazole has a hydrogen atom on the position-1 nitrogen atom, and thereby reacts with an epoxy group of the epoxidized diene rubber to be bound to the epoxidized diene rubber. Another epoxy group of the epoxidized diene rubber reacts with the bound imidazole ring, and thus, the polymer chains of the epoxidized diene rubber are bound via the imidazole to generate a negative ion (O⁻) of an oxygen atom together with the positively-charged imidazole ring. Thus, an imidazolium ion acts as a neutral repeating unit to allow the epoxidized diene rubber to form an ionomer, whereby crosslinking by an ionic bond (ionic crosslinking) is introduced into the epoxidized diene rubber (see S. Mandal et. al.). Thus, by the additional introduction of the ionic crosslinking by the imidazole, the strength of a crosslinked rubber can be improved. The reason is not particularly limited, but it is supposedly because the ionic crosslinking functions as a sacrifice bond in the system. Specifically, it is considered that the ionic crosslinking is preferentially broken as a sacrifice bond while dispersing the fracture energy to thereby increase the strength of the entire system.

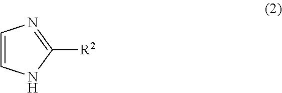

In the formula (2), R² represents a hydrogen atom or a methyl group. Thus, the imidazole is 1H-imidazole or 2-methyl-1H-imidazole, each of which may be used alone or which may be used in combination.

The amount of the imidazole relative to 100 parts by mass of the epoxidized diene rubber is preferably 0.5 to 15 parts by mass, more preferably 1 to 10 parts by mass, further preferably 1.5 to 8 parts by mass, and furthermore preferably 2 to 5 parts by mass.

The rubber composition according to this embodiment may contain a metal salt and/or an N-substituted imidazole for promoting an ester reaction of the dicarboxylic acid with the epoxidized diene rubber. The metal salt and/or N-substituted imidazole are components that promote an ester reaction, and hence, does not bind to the epoxidized diene rubber and does not act as a component that performs crosslinking.

The metal salt is not particularly limited, and examples thereof include heavy metal salts, such as a zinc salt (for example, zinc acetate, zinc chloride) and a manganese salt (for example, manganese acetate), and alkaline earth metal salts, such as a calcium salt (for example, calcium acetate) and a magnesium salt (for example, magnesium acetate). Any one of the metal salts can be used or two or more thereof can be used in combination.

The amount of the metal salt is not particularly limited, and may be 1 to 20 parts by mass or may be 2 to 15 parts by mass, relative to 100 parts by mass of the epoxidized diene rubber.

As the N-substituted imidazole, an imidazole in which the position-1 hydrogen atom of the imidazole ring is substituted with an alkyl group, a cycloalkyl group, an aryl group, or an aralkyl group can be used. Specific examples of the N-substituted imidazole include 1-methylimidazole, 1,2-dimethylimidazole, 1-butylimidazole, and 1-propylimidazole. Any one of the N-substituted imidazoles can be used or two or more thereof can be used in combination.

The amount of the N-substituted imidazole is not particularly limited, and may be 1 to 20 parts by mass or may be 3 to 10 parts by mass, relative to 100 parts by mass of the epoxidized diene rubber.

The rubber composition according to this embodiment may contain a filler. As the filler, for example, a carbon black and/or a silica is preferred. The carbon black is not particularly limited, and known various types can be used. The silica is not particularly limited, and examples thereof include a wet silica and a dry silica, and preferably, a wet silica, such as a wet precipitation method silica or a wet gelation method silica, is used.

The amount of the filler is not particularly limited, and can be appropriately set depending on the application. For example, the amount may be 10 to 200 parts by mass or may be 30 to 100 parts by mass, relative to 100 parts by mass of the rubber component.

In the rubber composition according to this embodiment, besides the above components, various additives which are generally used in a rubber composition, such as zinc oxide, stearic acid, an antioxidant, a wax, and an oil, may be blended.

The rubber composition according to this embodiment preferably does not substantially contain a vulcanizer, such as sulfur, or a vulcanization accelerator. This means that the rubber composition does not contain a vulcanizer, such as sulfur, and a vulcanization accelerator or, if contains, the total amount of the vulcanizer and the vulcanization accelerator relative to 100 parts by mass of the rubber component is preferably less than 1 part by mass, more preferably less than 0.5 parts by mass, and further preferably less than 0.2 parts by mass.

The rubber composition according to this embodiment can be produced by mixing with a generally used mixer, such as a Banbury mixer, a kneader, or a roll. The procedure of the mixing is not particularly limited. For example, (A) the dicarboxylic acid and the imidazole may be added to an epoxidized diene rubber at once, followed by mixing. Alternatively, (B) the dicarboxylic acid may be added to and mixed with an epoxidized diene rubber, and then, the imidazole may be added to and mixed with the resulting mixture. Alternatively, (C) the imidazole may be added to and mixed with an epoxidized diene rubber, and then, the dicarboxylic acid may be added to and mixed with the resulting mixture. Here, an additive, such as a filler, may be added to and mixed with the epoxidized diene rubber previously before the mixing of the dicarboxylic acid and the imidazole, or one or both of the dicarboxylic acid and the imidazole may be added to and mixed with the epoxidized diene rubber and then, the additive may be added to and mixed with the resulting mixture.

Furthermore, heat is applied to the thus obtained rubber composition to complete crosslinking, whereby a crosslinked rubber can be produced.

A crosslinked rubber according to an embodiment contains an epoxidized diene rubber crosslinked with a dicarboxylic acid represented by the formula (1) and an imidazole represented by the formula (2), and is produced by crosslinking the rubber composition. In the crosslinked rubber, into the epoxidized diene rubber, ionic crosslinking by the imidazole is introduced in addition to the crosslinking of an ester bond by the dicarboxylic acid, and thus, the crosslinked rubber has an improved strength. These crosslinkings are re-bindable bonds, and thus have a self-restoring property and a reprocessing property, and thus, the strength can be improved while achieving the material recycling.

A rubber composition or a crosslinked rubber according to an embodiment can be used in various rubber members, such as a tire, a vibrationproof rubber, and a conveyer belt. The rubber composition or the crosslinked rubber are preferably for a tire. In other words, a tire according to a preferred embodiment contains the crosslinked rubber. Examples of the tire include pneumatic tires for various applications and of various sizes, such as a tire for a passenger car and a large tire for a truck or bus, and the rubber composition or the crosslinked rubber can be applied in members, such as a tread, a side wall, and a bead part, of the tires.

### EXAMPLES

Examples will be described below, but the present invention is not to be limited to the examples.

ENR and DFA which were used in Examples and Comparative Examples are as follows.
ENR: epoxidized natural rubber, “Epoxyrene50” manufactured by Muang Mai Guthrie Public Company Limited (rate of epoxidation: 50% by mole)
DFA: dimer acid represented by the following formula, “Dimer acid, hydrogenated” manufactured by Sigma-Aldrich

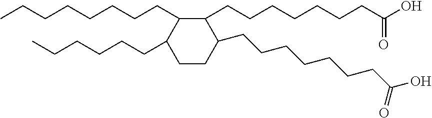 [SMILES: CCCCCCCCC1C(CCCCCC)CCC(CCCCCCCC(=O)O)C1CCCCCCCC(=O)O]

Preparation methods X, Y, and Z in Examples and Comparative Examples are as follows.
Preparation method X: With a Banbury mixer (“Labo plastomill 10S100” manufactured by Toyo Seiki Seisaku-sho, Ltd.), zinc acetate, 1,2-dimethylimidazole, and a dicarboxylic acid were added to ENR, and were mixed therewith for 10 minutes under conditions of 60° C. and 100 rpm. Then, with the Banbury mixer, 1H-imidazole was added to the resulting mixture and mixed therewith for 3 minutes under conditions of 60° C. and 100 rpm. Then, the resulting mixture was molded into a sheet with a thickness of 1 mm, which was heated at 170° C. for 60 minutes to produce a crosslinked rubber of a sheet form.
Preparation method Y: With a Banbury mixer (“Labo plastomill 10S100” manufactured by Toyo Seiki Seisaku-sho, Ltd.), 1H-imidazole was added to ENR and mixed therewith for 3 minutes under conditions of 60° C. and 100 rpm. Then, with the Banbury mixer, zinc acetate, 1,2-dimethylimidazole, and a dicarboxylic acid were added to the resulting mixture and mixed therewith for 10 minutes under conditions of 60° C. and 100 rpm. Then, the resulting mixture was molded into a sheet with a thickness of 1 mm, which was heated at 170° C. for 60 minutes to produce a crosslinked rubber of a sheet form.
Preparation method Z: With a Banbury mixer (“Labo plastomill 10S100” manufactured by Toyo Seiki Seisaku-sho, Ltd.), zinc acetate, 1,2-dimethylimidazole, and a dicarboxylic acid were added to ENR and mixed therewith for 10 minutes under conditions of 60° C. and 100 rpm. Then, the resulting mixture was molded into a sheet with a thickness of 1 mm, which was heated at 170° C. for 60 minutes to produce a crosslinked rubber of a sheet form.

The methods for evaluating the crosslinked rubbers of Examples and Comparative Examples are as follows.
Stress at 100% elongation: a tensile test according to JIS K6251:2017 (dumbbell-shaped No. 7 specimen, thickness: 1 mm) was performed to measure the tensile stress (MPa) at 100% elongation at 25° C. The measured tensile stress was designated as an index number relative to the value of Comparative Example 1 in Table 1, the value of Comparative Example 3 in Table 2, and the value of Comparative Example 4 in Table 3, taken as 100. A larger index number corresponds to a larger tensile stress at 100% elongation and means better fracture characteristics (mechanical strength).

### First Example

Crosslinked rubbers of Comparative Examples 1 to 2 and Examples 1 to 6 were each prepared according to the formulation (parts by mass) and preparation method shown in the following Table 1. The resulting crosslinked rubbers were evaluated for the stress at 100% elongation.

TABLE 1

| Formulation (parts by | Comp. | Comp. | | | | | | |
|---|---|---|---|---|---|---|---|---|
| mass) | Ex. 1 | Ex. 2 | Ex. 1 | Ex. 2 | Ex. 3 | Ex. 4 | Ex. 5 | Ex. 6 |
| ENR | 100 | 100 | 100 | 100 | 100 | 100 | 100 | 100 |
| DFA | 1.1 | 3.4 | 1.1 | 2.5 | 3.4 | 3.4 | 3.4 | 3.4 |
| Zinc acetate | 9.7 | 9.7 | 9.7 | 9.7 | 9.7 | 9.7 | 9.7 | 9.7 |
| 1,2-Dimethylimidazole | 7.3 | 7.3 | 7.3 | 7.3 | 7.3 | 7.3 | 7.3 | 7.3 |
| 1H-Imidazole | — | — | 4 | 4 | 2 | 2 | 4 | 4 |
| Preparation method | Z | Z | X | X | Y | X | Y | X |
| Stress at 100% | 100 | 122 | 150 | 171 | 191 | 157 | 241 | 174 |
| elongation (index | | | | | | | | |
| number) | | | | | | | | |

The results are as shown in Table 1. Comparative Examples 1 and 2 represent examples in which DFA was used as the dicarboxylic acid to introduce a crosslinking structure by ester bonds. Examples 1 to 6 represent examples in which ionic crosslinking by 1H-imidazole was introduced in addition to the ester bonds by DFA, and by introducing the ionic crosslinking, the strength was significantly improved as compared with Comparative Examples 1 and 2. By comparing Example 3 and Example 4, as the preparation method, Example 3 in which the ionic crosslinking was previously introduced was more superior in the strength improving effect than Example 4 in which a crosslinking structure by ester bonds was previously introduced. Also in comparison with Example 5 and Example 6 in which the amount of 1H-imidazole was increased, the same results were obtained.

### Second Example

Crosslinked rubbers of Comparative Example 3 and Examples 7 to 10 were each prepared according to the formulation (parts by mass) and preparation method shown in the following Table 2. The resulting crosslinked rubbers were evaluated for the stress at 100% elongation.

TABLE 2

| Formulation (parts by mass) | Comp. Ex. 3 | Ex. 7 | Ex. 8 | Ex. 9 | Ex. 10 |
|---|---|---|---|---|---|
| ENR | 100 | 100 | 100 | 100 | 100 |
| Sebacic acid | 1.2 | 1.2 | 1.2 | 1.2 | 1.2 |
| Zinc acetate | 9.7 | 9.7 | 9.7 | 9.7 | 9.7 |
| 1,2-Dimethylimidazole | 7.3 | 7.3 | 7.3 | 7.3 | 7.3 |
| 1H-Imidazole | — | 2 | 2 | 4 | 4 |
| Preparation method | Z | Y | X | Y | X |
| Stress at 100% elongation | 100 | 116 | 118 | 121 | 144 |
| (index number) | | | | | |

The results are as shown in Table 2. Also when the dicarboxylic acid was changed from DFA to sebacic acid, Examples 7 to 10 in which ionic crosslinking by 1H-imidazole was introduced in addition to ester bonds showed an improved strength as compared with Comparative Example 3 with only ester bonds. However, the degree of improvement was smaller than the case of DFA. The reason is not clear but it is presumed that sebacic acid gives a crosslinking chain shorter than that by DFA, and thus, sebacic acid enters into an ion association product by ionic crosslinking to break a part of the ion association product. Alternatively or additionally, the lower reactivity of sebacic acid than that of DFA is also considered to be a factor.

### Third Example

Crosslinked rubbers of Comparative Examples 4 to 8 were each prepared according to the formulation (parts by mass) and preparation method shown in Table 3. The resulting crosslinked rubbers were evaluated for the stress at 100% elongation.

TABLE 3

| Formulation | Comp. | Comp. | Comp. | Comp. | Comp. |
|---|---|---|---|---|---|
| (parts by mass) | Ex. 4 | Ex. 5 | Ex. 6 | Ex. 7 | Ex. 8 |
| ENR | 100 | 100 | 100 | 100 | 100 |
| Malonic acid | 0.6 | 0.6 | 0.6 | 0.6 | 0.6 |
| Zinc acetate | 9.7 | 9.7 | 9.7 | 9.7 | 9.7 |
| 1.2-Dimethylimidazole | 7.3 | 7.3 | 7.3 | 7.3 | 7.3 |
| 1H-Imidazole | — | 2 | 2 | 4 | 4 |
| Preparation method | Z | Y | X | Y | X |
| Stress at 100% elonga- | 100 | 88 | 85 | 90 | 88 |
| tion (index number) | | | | | |

The results are as shown in Table 3. When the dicarboxylic acid was changed to malonic acid, as shown in Comparative Examples 5 to 8, the strength improving effect was not recognized even if ionic crosslinking by 1H-imidazole is introduced in addition to ester bonds and the strength rather decreased. The fact that malonic acid gives a crosslinking chain further shorter than that by sebacic acid and also has a lower reactivity is considered to be a factor.

Note that, for each of various numerical ranges described in this specification, upper limits and lower limits thereof can be arbitrarily combined, and it is considered as if all such combinations are described as a preferred numerical range in this specification. The description of the numerical range “X to Y” means X or more and Y or less.

What is claimed is:

1. A rubber composition comprising a diene rubber having epoxy groups, a dicarboxylic acid represented by the following general formula (1), and an imidazole represented by the following general formula (2):
HOOC—R¹—COOH (1)
wherein R¹ represents a divalent hydrocarbon group having 3 to 50 carbon atoms which is optionally interrupted by one or more hetero atoms, 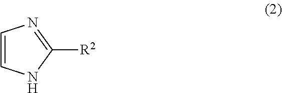
wherein R² represents a hydrogen atom or a methyl group.

2. The rubber composition according to claim 1, wherein the dicarboxylic acid is contained in an amount of 0.2 to 20 parts by mass relative to 100 parts by mass of the diene rubber.

3. The rubber composition according to claim 1 wherein the imidazole is contained in an amount of 0.5 to 15 parts by mass relative to 100 parts by mass of the diene rubber.

4. The rubber composition according to claim 2, wherein the imidazole is contained in an amount of 0.5 to 15 parts by mass relative to 100 parts by mass of the diene rubber.

5. The rubber composition according to claim 1, further comprising a metal salt.

6. The rubber composition according to claim 1, further comprising an N-substituted imidazole.

7. The rubber composition according to claim 1, further comprising a metal salt and an N-substituted imidazole.

8. A crosslinked rubber comprising a diene rubber having epoxy groups crosslinked with a dicarboxylic acid represented by the following general formula (1) and an imidazole represented by the following general formula (2):
HOOC—R¹—COOH (1)
wherein R¹ represents a divalent hydrocarbon group having 3 to 50 carbon atoms which is optionally interrupted by one or more hetero atoms: 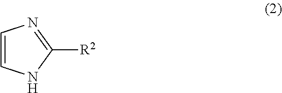
wherein R² represents a hydrogen atom or a methyl group.

9. A tire comprising the crosslinked rubber according to claim 8.
